(19) United States
(12) Patent Application Publication
(10) Pub. No.: US 2014/0267119 A1
(43) Pub. Date: Sep. 18, 2014

(54) METHOD AND APPARATUS FOR DISPLAYING SCREEN IN A PORTABLE TERMINAL

(71) Applicant: Samsung Electronics Co., Ltd., Gyeonggi-do (KR)

(72) Inventor: Ki-Hong Im, Gyeonggi-do (KR)

(73) Assignee: Samsung Electronics Co., Ltd., Gyeonggi-do (KR)

(21) Appl. No.: 14/214,021

(22) Filed: Mar. 14, 2014

(30) Foreign Application Priority Data
Mar. 15, 2013 (KR) 10-2013-0027888

(51) Int. Cl. G06F 3/041

(52) U.S. Cl. CPC G06F 3/0416
USPC 345/173

(57) ABSTRACT

A method for displaying a display screen on a portable terminal is provided. The method includes displaying an interface including a zoom-in area and a zoom-out area when a first touch input and a second touch input are detected; performing a zoom-in display of the display screen when the second touch input moves to the zoom-in area; and performing a zoom-out display of the display screen when the second touch input moves to the zoom-out area.

### CROSS-REFERENCE TO RELATED APPLICATION(S) AND CLAIM OF PRIORITY

The present application is related to and claims the priority under 35 U.S.C. §119(a) to Korean Application Serial No. 10-2013-0027888, which was filed in the Korean Intellectual Property Office on Mar. 15, 2013, the entire content of which is hereby incorporated by reference.

### TECHNICAL FIELD

Embodiments of the present disclosure relate to a screen display of a portable terminal. More specifically, the embodiments of the present disclosure relate to easily performing a zoom-in display or a zoom-out display of a screen on a portable terminal.

### BACKGROUND

A smart phone or a tablet PC implemented with an operating system such as Android or Tizen are generally used. The portable terminal such as a smart phone or a tablet PC generally receives an input of a user through a touch screen in addition to hardware keys according to the conventional art. For example, the user uses the portable terminal by zooming in or out the display screen by a multi-touch input on the touch screen.

Meanwhile, the function of zooming in or out the display screen by using the conventional multi-touch input provides a function of performing a zoom-out display or a zoom-in display of the display screen according to a distance between received touch inputs. At this point, the function of zoom-in display or zoom-out display of the display screen using the conventional multi-touch input can be a zoom-in pinch or a zoom-out pinch.

However, when using the conventional multi-touch input function, when the user desires to perform a zoom-in display or a zoom-out display of the display screen in a certain ratio or more, the zoom-in display or the zoom-out display may not be performed as much as desired by the user. Accordingly, when using the conventional multi-touch input function, the user should repeat the multi-touch input until the display screen is zoomed in or zoomed out as much as desired by the user.

Therefore, an easily and promptly performing zoom-in display or zoom-out display of a display screen without the cumbersome plurality of touch inputs for the zoom-in display or the zoom-out display of the display screen is needed.

### SUMMARY

To address the above-discussed deficiencies of the prior art, it is a primary object to provide an easily performing zoom-in display or zoom-out display of a display screen as desired by a user, without repetitive additional operations.

In order to accomplish this object, an aspect of the present disclosure provides a method of displaying a display screen on a portable terminal. The method includes displaying an interface including a zoom-in area and a zoom-out area when a first touch input and a second touch input are detected; performing a zoom-in display of the display screen when the second touch input moves to the zoom-in area; and performing a zoom-out display of the display screen when the second touch input moves to the zoom-out area.

In addition, another aspect of the present disclosure provides an apparatus for displaying a display screen on a portable terminal. The apparatus includes a display unit that includes a touch screen; a controller configured to display an interface including a zoom-in area and a zoom-out area when a first touch input and a second touch input are detected, to perform a zoom-in display of the display screen when the second touch input moves to the zoom-in area, and to performing a zoom-out display of the display screen when the second touch input moves to the zoom-out area.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a portable terminal according to certain embodiments of the present disclosure;

FIG. 2 is a flowchart illustrating a display screen in a portable terminal according to embodiments of the present disclosure;

FIG. 3A is a diagram illustrating a process for displaying a display screen of a portable terminal according to embodiments of the present disclosure;

FIG. 3B is a diagram illustrating a process for displaying a display screen of a portable terminal according to embodiments of the present disclosure; and

FIG. 3C is a diagram illustrating a process for displaying a display screen of a portable terminal according to embodiments of the present disclosure.

### DETAILED DESCRIPTION

FIGS. 1 to 3C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Embodiments of the present disclosure now will be described more fully hereinafter with reference to the accompanying drawings, in which embodiments of the disclosure are shown. Embodiments of the disclosure may be embodied in many different forms and should not be construed as limited to the embodiments set forth herein. Like numbers refer to like elements performing substantially the same function.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. The terminology used herein is for the purpose of describing certain embodiments only and is not intended to be limiting of the disclosure. As used herein, the singular forms are intended to include the plural forms as well, unless the context clearly indicates otherwise.

FIG. 1 is a block diagram illustrating a portable terminal according to certain embodiments of the present disclosure.

The various embodiments of the present disclosure are performed by a portable terminal, and it is assumed that the portable terminal is an electronic device easy to carry in weight and size. An example of the portable device according to the embodiments of the present disclosure can be an existing feature phone or an electronic device (for example, a smart phone or a tablet PC) that is driven by an operating system such as Bada, Tizen, Windows (for example, Windows 8), iOS, or Android. Further, the portable terminal according to the embodiments of the present disclosure can be a notebook computer, a digital camera, a video phone, or the like. The portable terminal according to the embodiments of the present disclosure is not limited to the devices described above.

With reference to FIG. 1, a portable terminal 100 can be connected to an external device (not illustrated) using an external device connecting unit such as a sub-communication module 130, a connector 165, and an earphone connecting jack 167. The external device can include various devices such as an earphone, an external speaker, a Universal Serial Bus (USB) memory, a charger, a Cradle/Dock, a DMB antenna, a mobile payment related device, a health care apparatus (such as a blood glucose monitor), a gaming machine, and a car navigation, which are detachably attached to the portable terminal 100 and connectable by wire. Further, the “external device” can include a local area network device such as a Bluetooth communication device and a Near Field Communication (NFC) device, a WiFi direct communication device, a wireless Access Point (AP), which are wirelessly connectable to the portable terminal 100 by a local area network. Further, the external device can include other devices, a cellular phone, a smart phone, a tablet PC, a desk top PC, and a server.

With reference to FIG. 1, the portable terminal 100 includes a controller 110, a mobile communication module 120, the sub-communication module 130, a multimedia module 140, a camera module 150, a GPS module 155, an input/output module 160, a sensor module 170, a storage unit 175, a power supply unit 180, and a display unit 190. The sub-communication module 130 includes one or more of a wireless LAN module 131 and a local area network module 132. The multimedia module 140 includes one or more of a broadcast communication module 141, an audio reproduction module 142, and a video reproduction module 143. The camera module 150 includes one or more of a first camera 151 and a second camera 152. The input/output module 160 includes one or more of buttons 161, a microphone 162, a speaker 163, a vibration motor 164, a connector 165, and a keypad 166.

The mobile communication module 120 connects the portable terminal 100 to an external device via wireless communication using one or more antennas (not illustrated) under the control of the controller 110. The mobile communication module 120 transmits/receives a wireless signal for a voice communication, a video communication, a Short Message Service (SMS), or a Multimedia Message Service (MMS), with a cellular phone (not illustrated), a smart phone (not illustrated), a tablet PC, or another device (not illustrated), which has phone numbers included in the portable terminal 100.

The sub-communication module 130 can include one or more of the wireless LAN module 131 and the local area network module 132. For example, the sub-communication module 130 can include the wireless LAN module 131 and the local area network module 132 singly or in combination.

The wireless LAN module 131 includes a Wi-Fi module, and can be connected to the Internet where a wireless Access Point (AP) (not illustrated) is installed, in association with the controller 110. The wireless LAN module 131 conforms to wireless Local Area Network (LAN) standard (IEEE 802.11x) of Institute of Electrical and Electronics Engineers (IEEE).

The local area network module 132 provides a wireless local area network function, in association with the controller 110. The local area network module 132 includes a Bluetooth module, an Infrared Data Association (IrDA) module, a Near Field Communication (NFC) module, and the like.

The multimedia module 140 can include the broadcast communication module 141, the audio reproduction module 142, or the video reproduction module 143. The broadcast communication module 141 can receive broadcast signals (for example, TV broadcast signals, radio broadcast signals, or data broadcast signals) or additional broadcast information (for example, Electric Program Guide (EPS) or Electric Service Guide (ESG)), which is transmitted through a broadcast antenna (not illustrated) from a broadcasting station under the control of the controller 110. The audio reproduction module 142 can reproduce digital audio files (for example, files with extensions of mp3, wma, ogg, or way), which are stored or received under the control of the controller 110. The video reproduction module 143 can reproduce digital movie files (for example, files with extensions of mpeg, mpg, mp4, avi, mov, or mkv) which are stored or received under the control of the controller 110. The video reproduction module 143 can store digital audio files.

The multimedia module 140 includes the audio reproduction module 142 and the video reproduction module 143 except the broadcast communication module 141. Further, the audio reproduction module 142 or the video reproduction module 143 of the multimedia module 140 can be included in the controller 110.

The camera module 150 can include one or more of the first camera 151 and the second camera 152 which capture still images or moving images under the control of the controller 110. Further, the first camera 151 or the second camera 152 can include an auxiliary light source (for example, a flash (not illustrated)) that provides light intensity required for capturing images. The first camera 151 is disposed on the front surface of the portable terminal 100, and the second camera 152 is disposed on the rear surface of the portable terminal 100. According to another embodiment, the first camera 151 and the second camera 152 can be contiguously arranged (for example, a distance between the first camera 151 and the second camera 152 is longer than 1 cm and shorter than 8 cm) to capture 3-dimensional still images or 3-dimensional moving images.

The GPS module 155 receives electric signals from a plurality of GPS satellites (not illustrated) in Earth orbit, and can calculate a position of the portable terminal 100 using Time of Arrival (TOA) from a GPS satellite to the portable terminal 100.

The input/output module 160 can include one or more of a plurality of buttons 161, the microphone 162, the speaker 163, the vibration motor 164, the connector 165, and the keypad 166.

The buttons 161 can be formed on a front surface, a side surface, or a rear surface of a housing of the portable terminal 100, and can include one or more of a power/lock button (not illustrated), a volume button (not illustrated), a menu button, a home button, a back button, and a search button.

The microphone 162 receives a voice or a sound and generates an electric signal under the control of the controller 110.

The speaker 163 can output a sound corresponding to various signals (for example, wireless signals, broadcast signals, digital audio files, digital video files, or image capture) of the mobile communication module 120, the sub-communication module 130, the multimedia module 140, or the camera module 150, to the outside of the portable terminal 100 under the control of the controller 110. The speaker 163 outputs a sound (for example, a button operation sound or a ring back tone corresponding to a telephone communication) corresponding to a function performed by the portable terminal 100. One or more speakers 163 can be formed on a position or positions of a housing of the portable terminal 100.

The vibration motor 164 can convert an electric signal to a mechanical vibration under the control of the controller 110. For example, the portable terminal 100 in a vibration mode operates the vibration motor 164, when a voice communication is received from another device (not illustrated). One or more vibration motors 164 can be formed in the housing of the portable terminal 100. The vibration motor 164 can operate in response to a touch operation of a user touching the touch screen 191 or a continuous movement of a touch operation on the touch screen 191.

The connector 165 can be used as an interface for connecting the portable terminal 100 to an external device (not illustrated) or a power source (not illustrated). The portable terminal 100 can transmit data stored in the storage unit 175 of the portable terminal 100 by wire connected to the connector 165 under the control of the controller 110 or receive data from an external device (not illustrated). Further, the portable terminal 100 can receive power from a power source through a wire cable connected to the connector 165 or can recharge a battery (not illustrated) using the power source.

The keypad 166 can receive key input from a user for controlling the portable terminal 100. The keypad 166 includes a physical keypad (not illustrated) formed on the portable terminal or a virtual keypad (not illustrated) displayed on the touch screen 191. The physical keypad (not illustrated) formed on the portable terminal 100 may not be provided according to the performance or the structure of the portable terminal 100.

An earphone can be inserted into the earphone connecting jack 167 (not illustrated) to be connected to the portable terminal 100.

The sensor module 170 can include at least one sensor that senses the state of the portable terminal 100. For example, the sensor module 170 can include a proximity sensor that senses whether the user is close to the portable terminal 100, an illumination sensor (not illustrated) that senses light intensity around the portable 100, a motion sensor (not illustrated) that senses an operation (for example, the rotation of the portable terminal 100 or an acceleration or vibration applied to the portable terminal 100) of the portable terminal 100, a geo-magnetic sensor, (not illustrated) that senses a point of a compass using the Earth's magnetic field, a gravity sensor that senses a working direction of gravity, and an altimeter that senses the altitude by measuring an air pressure. At least one sensor detects the state, and generates the signal corresponding to the detection to transmit the signal to the controller 110. The sensor of the sensor module 170 can be added or deleted according to the performance of the portable terminal 100.

The storage unit 175 can store signals or data input/output according to operations of the mobile communication module 120, the sub-communication module 130, the multimedia module 140, the camera module 150, the GPS module 155, the input/output module 160, the sensor module 170, and the touch screen 191, under the control of the controller 110. The storage unit 175 can store a control program or applications for controlling the portable terminal 100 or the controller 110. At this point, the terminology of “storage unit” may refer to the storage unit 175, a ROM 112 or a RAM 113 in the controller 110.

Further, the storage unit 175 can further include an external memory such as Compact Flash (CF), Secure Digital (SD), Micro Secure Digital (Micro-SD), Mini Secure Digital (Mini-SD), Extreme Digital (xD), or Memory Stick. Further, the storage unit 175 can include a disc storage device such as a Hard Disk Drive (HDD) or a Solid State Disk (SSD).

The power supply unit 180 can supply power to one or more batteries (not illustrated) included in the housing of the portable terminal 100 under the control of the controller 110. One or more batteries (not illustrated) provide power for the portable terminal 100. Further, the power supply unit 180 can supply power input from an external power source (not illustrated) through a wire cable connected to the connector 165, to the portable terminal 100. Further, the power supply unit 180 can supply power wirelessly input from an external power source using a wireless charging technology, to the portable terminal 100.

The display unit 190 can be formed by a Liquid Crystal Display (LCD) or an Organic Light Emitting Diode (OLED) such as a Passive-Matrix Organic Light Emitting Diode (PMOLED) or an Active-Matrix Organic Light Emitting Diode (AMOLED), and outputs various kinds of display information. The display unit 190 can include the touch screen 191 (for example, a Touch Screen Panel (TSP)) implemented by a resistive scheme, a capacitive scheme, an infrared scheme, an acoustic wave scheme, or the like or a touch screen controller. Further, the display unit 190 can include a controller corresponding to a panel that receives a pen input (for example, an input of S pen of Samsung Electronics Co., Ltd.) of a user by an electromagnetic induction scheme, in addition to the touch screen 191.

The display unit 190 can provide the user with user interfaces corresponding to various services (for example, a telephone conversation, a data transmission, broadcast, and image capture). The touch screen 191 of the display unit 190 can transmit analog signals corresponding to at least one touch input to the user interfaces to a touch screen controller (not illustrated). The display unit 190 can receive at least one touch input through the body of the user (for example, a finger including the thumb) or a touchable input unit (for example, a stylus pen) through the touch screen 191.

The touch according to the present disclosure is not limited to the touch of the display unit (for example, a touch screen) with the body of the user or the touchable input unit, but the touch can also include a non-contact (for example, a detectable distance between the touch screen and the body of the user or the touchable input unit is 1 mm or less).

The touch screen controller converts an analog signal received from the touch screen 191 of the display unit 190 into a digital signal (for example, x-y coordinates), and transmits the converted signal to the controller 110. The controller 110 can use the digital signal received from the touch screen controller to control the touch screen 191 of the display unit 190. For example, the controller 110 can perform a control so that an application icon displayed on the display unit 190 is selected or a corresponding application is executed. At this point, the touch screen controller can be included in the controller 110.

The controller 110 can include the ROM 112 that stores a control program for controlling a CPU 111 of the portable terminal 100, and the RAM 113 that stores signals or data received from the outside of the portable terminal 100 or that is used as a storage area for an operation performed in the portable terminal 100. The CPU 111 can be a multi-core processor comprising one or more of a single-core processor, a dual-core processor, a triple-core processor, and a quad-core processor. The CPU 111, the ROM 112, and the RAM 113 can be interconnected through an internal bus.

The controller 110 can control the mobile communication module 120, the sub-communication module 130, the multimedia module 140, the camera module 150, the GPS module 155, the input/output module 160, the sensor module 170, the storage unit 175, the power supply unit 180, and the display unit 190.

According to embodiments of the present disclosure, the controller 110 is configured to display an interface including a zoom-in area and a zoom-out area when a first touch input and a second touch input are detected, enlarging a display screen when the second touch input moves to the zoom-in area, and reducing the display screen when the second touch input moves to the zoom-out area. The detailed operations of the controller 110 according to embodiments of the present disclosure will be described as follows.

FIG. 2 is a flowchart illustrating a display screen in a portable terminal according to embodiments of the present disclosure. FIGS. 3A to 3C are diagrams illustrating processes for displaying a display screen of a portable terminal according to embodiments of the present disclosure. With reference to the drawings, embodiments of the present disclosure will be described as follows.

In steps S201 to S203, a controller 110 is configured to check (S202) input points of a first touch input and a second touch input when the first touch input and the second touch input are detected (S201) on a display screen of the display unit 190, and displays (S203) an interface including a zoom-in area, a neutral area, and a zoom-out area based on the checked input points.

The user may need a zoom-in display or a zoom-out display of the display screen during searching or using information by a web browser or viewing content (for example, still images or moving images) via the display screen of the display unit 190 providing a touch screen function

According to embodiments of the present disclosure, the user may request a zoom-in display or a zoom-out display of the display screen by inputting the first touch input and the second touch input of touching two arbitrary points on the display screen. when the first touch input and the second touch input from the user are detected (S201), the controller 110 is configured to check the input points of the first touch input and the second touch input (S202), and display an interface that can perform a zoom-in display or a zoom-out display of the display screen based on the detected input points (S203).

With reference to FIG. 3A, when inputs of a first touch input 310 and a second touch input 320 from the user are detected, the controller 110 can perform a control for displaying an interface including a zoom-out area 330, a neutral area 340, and an zoom-in area 350 (for example, an interface for performing a zoom-in display or a zoom-out display of the display screen) based on the input points of the first touch input 310 and the second touch input 320. At this point, overlay display of the interface including the zoom-out area 330, the neutral area 340, and the zoom-in area 350 is performed in a predetermined transparency. Accordingly, the user can easily check the display screen (for example, contents displayed on the display screen are checked) during the display of the interface.

The zoom-out area 330 in FIG. 3A is an input area for performing a zoom-out display of the display screen by the touch input of the user, and the zoom-in area 350 is an input area for performing a zoom-in display of the display screen by the touch input of the user. The neutral area 340 in FIG. 3A is an area for dividing the zoom-out area 330 and the zoom-in area 350 where the display screen is not zoomed in or zoomed out when the touch input of the user is input.

Meanwhile, according to embodiments of the present disclosure, the zoom-out area 330, the neutral area 340, and the zoom-in area 350 are displayed in forms of concentric circles with a point where the first touch input 310 is detected as a center, and the neutral area 340 is displayed where the second touch input 320 is detected. The zoom-out area 330, the neutral area 340, and the zoom-in area 350 are displayed in forms of concentric circles for an easy touch input. The display form can be modified according to certain embodiments.

Further, according to certain embodiments of the present disclosure, the interface including the zoom-out area 330, the neutral area 340, and the zoom-in area 350 may not include the neutral area 340. For example, when the first touch input and the second touch input are detected, the controller 110 can perform a control for displaying an interface in which two input areas of the zoom-out area 330 and the zoom-in area are 350 displayed.

Further, according to embodiments of the present disclosure, the zoom-out area 330, the neutral area 340, and the zoom-in area 350 are displayed with different colors so that the user may easily recognize the areas. For example, the zoom-out area 330, the neutral area 340, and the zoom-in area 350 can be displayed in red, yellow, and blue, respectively.

Further, according to embodiments of the present disclosure, the user can be informed that the zoom-out area 330 and the zoom-in area 350 are areas where the display screen can be zoomed in or zoomed out. For example, visual information (for example, a message) for the zoom-out area 330 and the zoom-in area 350 can be displayed on the zoom-out area 330 and the zoom-in area 350.

In steps S204 to S205, the controller 110 is configured so that the display screen is zoomed in (S205) when the second touch input moves (S204) to the zoom-in area 350.

As described above, when the interface including the zoom-out area 330, the neutral area 340, and the zoom-in area 350 is displayed, the user may move the second touch input 320 to the zoom-out area 330 and the zoom-in area 350 with the first touch input 310 maintained.

With reference to FIG. 3B, the user may request to move the input position of the currently input second touch input to the zoom-in area 350 in a direction, for example, from 320 to 320b, by moving the touch input unit (for example, a finger) in a direction, for example, from 360 to 360b. when the input position of the second touch input moves to the zoom-in area 350, the controller checks (or detects) a duration time (input time) of the moved second touch input staying in the zoom-in area 350 and performs a control for performing a zoom-out display of the display screen corresponding to the checked duration time. For example, while the second touch input is input in the zoom-in area 350, the display area may be continuously zoomed in.

Therefore, after requesting to display the zoom-out area 330 and the zoom-in area 350 by inputting the first touch input and the second touch input, the user moves the second touch input to the zoom-in area 350, and can adjust a degree of the zoom-in display of the display screen by adjusting the input time (for example, a touch duration time) of the second touch input on the zoom-in area 350.

Meanwhile, embodiments of the present disclosure provide a function of controlling a speed of the zoom-in display or the zoom-out display of the display screen according to a distance between the moved second touch input and the first touch input, together with (or separate from) the input time (or the duration time) of the second input on the zoom-in area 350.

With reference to FIGS. 3B and 3C, when the input point of the second touch input moves from 320 to 320b, the controller checks an input point of the moved second touch input, and performs the zoom-in display of the display screen at a zoom-in display speed corresponding to the checked input point (for example, dᵢ).

According to embodiments of the present disclosure, the zoom-in display speed V_{zi} increases in proportion to a distance between the input point of the first touch input 310 and the moved input point of the second touch input 320b or dᵢ as expressed with Equation 1 illustrated in FIG. 3C. In Equation 1, V_{zi.max} refers to the maximum zoom-in display speed, d_{zi} refers to a distance of the entire section of the zoom-in area 350, and dᵢ refers to a movement distance of the second touch input in the zoom-in area 350.

According to embodiments of the present disclosure, the user can control the zoom-in display speed of the display area by adjusting the movement distance (for example, dᵢ) of the second touch input that moves to the zoom-in area 350.

For example, when the user desires to perform the zoom-in display of the display screen at a maximum speed, the user can request to perform the zoom-in display of the display screen at the speed of V_{zi.max}, by moving the second touch input to the outermost border of the zoom-in area 350. Meanwhile, when the user desires to perform the zoom-in display of the display screen at a minimum speed, the user can request to perform the zoom-in display of the display screen, by moving the second touch input to the innermost border of the zoom-in area 350.

In steps S206 to S207, when the second touch input moves (S206) to the zoom-out area 330, the controller 110 is configured to perform (S207) a zoom-out display of the display screen.

As described with reference to steps S204 to S205, the user can move the second touch input 320 while maintaining the first touch input 310 to the zoom-out area 330, through the interface including the zoom-out area 330, the neutral area 340, and the zoom-in area 350.

With reference to FIG. 3B, the user can request to move the input position of the inputting second touch input to the zoom-out area 330 in a direction, for example, from 320 to 320a, by moving (for example, dragging the finger) the touch input unit (for example, the finger) in a direction, for example, from 360 to 360a. When the input position of the second touch input moves to the zoom-out area 330, the controller checks the time when the moved second touch input is input in the zoom-out area 330 and performs a control for performing the zoom-in display of the display screen corresponding to the checked input time.

Similarly to the case of the second touch input in the zoom-in area 350 described above, when the first touch input and the second touch input are input and the zoom-out area 330 and the zoom-in area 350 are displayed, the user can adjust the degree of the zoom-out display of the display screen by moving the second touch input to the zoom-out area 330, and then adjusting the input time (for example, the touch duration time) of the second touch input in the zoom-out area 330.

Further, similarly to the zoom-in display in the zoom-in area 350 described above, embodiments of the present disclosure can provide a function of adjusting a degree of the zoom-out display of the display screen by adjusting the degree of the input time of the second touch input in the zoom-out area 330, and further adjusting the speed of the zoom-out display of the display screen according to a distance of the first touch input and the second touch input moving to the zoom-out area 330.

With reference to FIGS. 3B and 3C, when the input point of the second touch input moves in a direction from 320 to 320a, the controller 110 checks the moved input point of the second touch input and performs a zoom-in display of the display screen at the zoom-out display speed corresponding to the checked input point (for example, dₒ).

For example, as expressed by Equation 2 illustrated in FIG. 3C, the zoom-out speed V_{zo} increases in inverse proportion to a distance between the input point of the first touch input 310 and the moved input point of the second touch input 320a or dₒ. In Equation 2, V_{zo.max} refers to the maximum zoom-out display speed, d_{zo} refers to a distance of the entire section of the zoom-out area, and dₒ is the movement distance of the second touch input in the zoom-out area.

Therefore, the user can control the zoom-out display speed of the display screen, by adjusting the movement distance of the second touch input that moves to the zoom-out area.

For example, when the user desires to perform a zoom-out display of the display screen at the maximum speed, the user can request the zoom-out display of the display screen at the speed of V_{zo.max} by moving the second touch input to the innermost border of the zoom-out area. When the user desires to perform a zoom-out display of the display screen at the minimum speed, the user can request the zoom-out display of the display screen by moving the second touch input to the outermost border of the zoom-out area.

Embodiments of the present disclosure provide an effect of performing a zoom-in display or the zoom-out display of the display screen as desired by the user, with minimum time and input.

Methods according to embodiments of the present disclosure can be implemented in a program command form that can be executed through various computer elements and can be recorded in a computer readable recording medium. The computer readable recording medium can include program commands, data files, data structures, etc., individually or in combination. The program command recorded in the computer readable recording medium can be a program command designed specifically for an embodiment of the disclosure or can be a program command well-known to one of ordinary skill in the art.

Although the present disclosure has been described with certain embodiments, various changes and modifications may be apparent to one of ordinary skill in the art. It is intended that the present disclosure encompass such changes and modifications as falling within the scope of the appended claims.

What is claimed is:

1. A method for displaying a display screen on a portable terminal, the method comprising:
displaying an interface including a zoom-in area and a zoom-out area when a first touch input and a second touch input are detected;
performing a zoom-in display of the display screen when the second touch input moves to the zoom-in area; and
performing a zoom-out display of the display screen when the second touch input moves to the zoom-out area.

2. The method according to claim 1, wherein the displaying of the interface comprises:
displaying the interface including the zoom-in area, a neutral area, and the zoom-out area when the first touch input and the second touch input are detected,
wherein the neutral area is an area that divides the zoom-in area and the zoom-out area.

3. The method according to claim 2, wherein the zoom-in area, the neutral area, and the zoom-out area are displayed in forms of concentric circles with a point where the first touch input is detected as a center of the concentric circles.

4. The method according to claim 2, wherein the neutral area is displayed at a point where the second touch input is detect, and
the display screen is not zoomed in or zoomed out when a touch of a user is input in the neutral area.

5. The method according to claim 1, wherein the performing of the zoom-in display comprises:
detecting a time when the second touch input is performed in the zoom-in area when the second touch input moves to the zoom-in area; and
performing the zoom-in display of the display screen corresponding to the detected time.

6. The method according to claim 5, wherein the performing of the zoom-in display comprises:
checking a distance between the first touch input and the second touch input moving to the zoom-in area, when the second touch input moves to the zoom-in area, and
performing the zoom-in display of the display screen at a speed corresponding to the checked distance.

7. The method according to claim 6, wherein the performing of the zoom-in display comprises performing the zoom-in display of the display screen at a speed increasing in proportion to the checked distance.

8. The method according to claim 1, wherein the performing of the zoom-out display comprises:
detecting a time when the second touch input is performed in the zoom-out area when the second touch input moves to the zoom-out area; and
performing the zoom-out display of the display screen corresponding to the detected time.

9. The method according to claim 8, wherein the performing of the zoom-in display comprises:
checking a distance between the first touch input and the second touch input moving to the zoom-out area, when the second touch input moves to the zoom-out area, and
performing the zoom-out display of the display screen at a speed corresponding to the checked distance.

10. The method according to claim 9, wherein the performing of the zoom-out display comprises performing the zoom-out display of the display screen at a speed in reverse proportion to a distance between the moved second touch input and the first touch input.

11. The method according to claim 1, wherein an overlay display of the interface is performed on the display screen in a predetermined transparency.

12. An apparatus for displaying a display screen on a portable terminal, the apparatus comprising:
a display unit that includes a touch screen; and
a controller configured to display an interface including a zoom-in area and a zoom-out area when a first touch input and a second touch input are detected, perform a zoom-in display of the display screen when the second touch input moves to the zoom-in area, and perform a zoom-out display of the display screen when the second touch input moves to the zoom-out area.

13. The apparatus according to claim 12, wherein the controller is further configured to display the interface including the zoom-in area, a neutral area, and the zoom-out area when the first touch input and the second touch input are detected,
wherein the neutral area is an area that divides the zoom-in area and the zoom-out area.

14. The apparatus according to claim 13, wherein the zoom-in area, the neutral area, and the zoom-out area are displayed in forms of concentric circles with a point where the first touch input is detected as a center of the concentric circles.

15. The apparatus according to claim 13, wherein the controller is configured to display the neutral area at a point where the second touch input is detected, and the display screen is not zoomed in or zoomed out when a touch of a user is input in the neutral area.

16. The apparatus according to claim 12, wherein the controller is further configured to detect a time when the second touch input is performed in the zoom-in area when the second touch input moves to the zoom-in area, and to perform the zoom-in display of the display screen corresponding to the detected time.

17. The apparatus according to claim 16, wherein the controller is further configured to check a distance between the first touch input and the second touch input moving to the zoom-in area, when the second touch input moves to the zoom-in area, and to perform the zoom-in display of the display screen at a speed corresponding to the checked distance.

18. The apparatus according to claim 17, wherein the controller is further configured to perform the zoom-in display of the display screen at a speed increasing in proportion to the checked distance.

19. The apparatus according to claim 12, wherein the controller is further configured to detect a time when the second touch input is performed in the zoom-out area when the second touch input moves to the zoom-out area, and to perform the zoom-out display of the display screen corresponding to the detected time.

20. The apparatus according to claim 17, wherein the controller is further configured to check a distance between the first touch input and the second touch input moving to the zoom-out area, when the second touch input moves to the zoom-out area, and to perform the zoom-out display of the display screen at a speed corresponding to the checked distance.

21. The apparatus according to claim 20, wherein the controller is further configured to perform the zoom-out display of the display screen at a speed in reverse proportion to a distance between the moved second touch input and the first touch input.

22. The apparatus according to claim 12, wherein the controller is further configured to performs an overlay display of the interface on the display screen in a predetermined transparency.
